(19) United States
(12) Patent Application Publication
(10) Pub. No.: US 2021/0295203 A1
(43) Pub. Date: Sep. 23, 2021

(54) PRECISE CHATBOT-TRAINING SYSTEM

(71) Applicant: International Business Machines Corporation, Armonk, NY (US)

(72) Inventors: Qingzi Liao, White Plains, NY (US); Biplav Srivastava, Rye, NY (US); Yunfeng Zhang, Chappaqua, NY (US); Rachel Katherine Emma Bellamy, Bedford, NY (US)

(21) Appl. No.: 16/822,288

(22) Filed: Mar. 18, 2020

(51) Int. Cl. G06N 20/00; H04L 12/58

(52) U.S. Cl. CPC G06N 20/00; H04L 51/02

(57) ABSTRACT

A method of training a chatbot comprises obtaining a set of utterances. The method also comprises identifying a set of intents associated with utterances within the set of utterances. The method further comprises organizing intents within the set of intents hierarchically. This may result in a customized intent hierarchy. The method further comprises created a list of intents within the customized intent hierarchy.

### BACKGROUND

The present disclosure relates to automated conversation agents (sometimes referred to herein as “automated chatbots” or simply “chatbots”), and more specifically, to efficiently training automated chatbots.

Automated chatbots (also referred to herein as “chatbots”) are typically designed to receive an utterance from a user, identify the intent of that utterance, match that intent with a pre-programmed response, and provide the response to the user. In this way, some chatbots are able to imitate a conversation between the user and another person. The level of detail with which a chatbot is configured to converse on a particular topic is sometimes referred to as the chatbot's granularity with respect to that topic. The granularity of different chatbots on a set of topics may differ based on the intended use cases of those chatbots.

As the granularity of a chatbot increases, the resources required to train that chatbot also increases. The amount of topics a chatbot is expected to be able to discuss can also significantly increase the amount of resources necessary to train a chatbot. Each of these topics may have a separate degree of granularity. When the granularity of all or most of the topics a chatbot is required to discuss is high, training the chatbot can be a very resource-intensive task.

Because the amount of resources required to operate a chatbot can increase drastically as the granularity of the chatbot increases, designing a chatbot with high granularity only on topics that the chatbot is expected to be able to converse with specificity can result in significant resource savings. However, prior-art processes for precisely designing a chatbot require significant manual interaction on the part of chatbot developers and the future owners of a chatbot. a very time-consuming activity.

The typical process for training a chatbot, for example, requires that the individuals for whom or by whom the chatbot is being designed spend a significant amount of time manually planning the granularity for the chatbot and overseeing the development process to increase the likelihood that the chatbot is not imprecisely trained.

For these reasons, developing a chatbot with precise granularity for a new chatbot can be significantly expensive and time consuming.

### SUMMARY

Some embodiments of the present disclosure can be illustrated as a method of training a chatbot. The method may comprise obtaining a set of utterances. The method may further comprise identifying a set of intents associated with utterances within the set of utterances. The method may further comprise organizing intents within the set of intents hierarchically. This organizing may result in a customized intent hierarchy. The method may also comprise creating a list of intents within the customized intent hierarchy. This customized intent hierarchy may advantageously be used to train a chatbot with granularity that precisely reflects the intents that are customized for the chatbot.

Some embodiments of the present disclosure can be illustrated as a second method of training a chatbot. The second method comprises the first method, and also comprises presenting a first utterance to a chatbot trainer via a graphical user interface (sometimes referred to herein as a “GUI”). The second method may further comprise obtaining a response to the first utterance. The second method may further comprise presenting a second utterance to the chatbot trainer via the GUI. The second method may further comprise receiving an indication that the response could also address the second utterance. The second method may further comprise identifying a first intent that is associated with the first utterance. The second method may further comprise identifying a second intent that is associated with the second utterance. The second method may finally comprise merging the first intent and the second intent. This second method may advantageously be used to further streamline the training of a chatbot with granularity that precisely reflects the intents that are customized for the chatbot.

Some embodiments of the present disclosure can be illustrated as a third method of training a chatbot. In the third method, the intent hierarchy is organized into intent clusters. This second method may advantageously be used to efficiently manage to customization of an intent hierarchy for a chatbot.

Some embodiments of the present disclosure may also be illustrated as a system or computer program product configured to perform the above methods.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts an example method of training a chatbot with precise granularity using a customized intent hierarchy, in accordance with embodiments.

FIG. 2A depicts an abstract illustration of an example intent hierarchy, in accordance with embodiments.

FIG. 2B depicts an abstract illustration of the intent hierarchy after customization, in accordance with embodiments.

FIG. 3 depicts an example method of customizing an intent hierarchy in accordance with embodiments.

FIG. 4 depicts an example method of creating a logic flow using an example conversation, in accordance with embodiments.

FIG. 5 illustrates the representative major components of a neural network that may be used in accordance with embodiments.

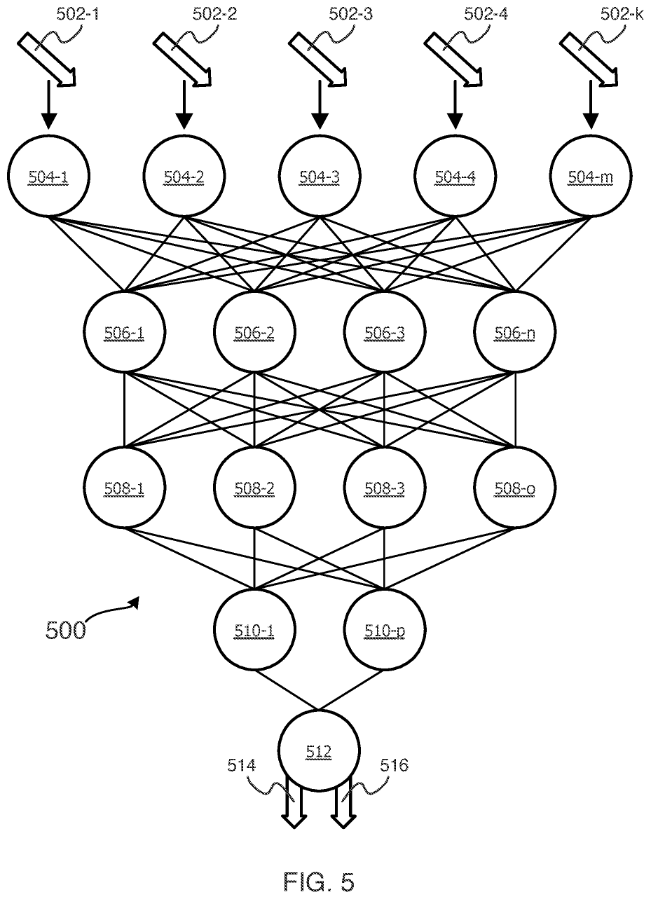

FIG. 6 depicts the representative major components of a computer system that may be used in accordance with embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to automated chatbots, more particular aspects relate to training automated chatbots. While the present disclosure is not necessarily limited to such applications, various aspects of the disclosure may be appreciated through a discussion of various examples using this context.

In a typical conversation between an end user and a chatbot, the chatbot may receive several utterances from the end user. Typical chatbots are configured to, upon receiving one of these utterances, analyze the utterance to determine the intent of the utterance and to determine the appropriate response for that intent. In other words, when a chatbot receives an utterance in a user message, it may detect an intent in the utterance that matches an intent stored in the chatbot's memory. Once an intent is recognized, a chatbot may determine the response the chatbot is configured to provide for that intent, and provide that response in a message to the user.

For example, at the start of a conversation, a chatbot may receive a user utterance that states “Hello chatbot.” The chatbot may be configured to analyze that utterance and determine that the intent of the utterance is to provide a greeting. The chatbot may then be configured to determine the appropriate response when it receives an utterance with a “greeting” intent. In some instances, the appropriate response may be determined solely by the received intent. For example, some chatbots may be configured to always respond “Hello,” to any greeting utterance received by the chatbot. However, in some instances the appropriate response may also be determined by other factors. For example, some chatbots may be configured to respond “Good morning” or “Good evening” to a greeting utterance based on the time of day at which the greeting utterance is received.

Further, the granularity of intents that a chatbot is configured to recognize can also vary from chatbot to chatbot. In other words, some chatbots may be configured to differentiate between multiple intents among a set of utterances, whereas other chatbots may broadly recognize the same general intent among all utterances in the set. Chatbots that have the ability to detect intents with higher granularity may also be configured to respond more specifically to user messages that contain those intents.

For example, some chatbots may be expected to provide one response to a first utterance that states “Howdy” and another response to a second utterance that states “Salutations.” In this example, the first utterance may be classified as having an “informal greeting” intent.” Similarly, the second utterance may be classified as having a “formal greeting” intent. The chatbot may be configured to respond to an utterance with the “informal greeting” intent with an informal message (i.e., an utterance) that states “Hi there,” and to respond to an utterance with the “formal greeting” intent with a formal message that states “Greetings.” However, some chatbots may only be configured to recognize a “greeting” intent, and thus may respond to both informal and formal greetings with the same message (e.g., “Hello.”). In other words, those chatbots may not be configured to differentiate between greetings of different types, but may respond to all utterances that are intended to greet the chatbot with the same message. In these examples, the chatbot that is able to recognize an informal greeting and a formal greeting may be referred to as having a higher granularity (with respect to greeting intents) than a chatbot that is only able to recognize a general greeting regardless of formality.

As the granularity of a chatbot increases, the resources required to train and operate that chatbot also increases. One reason for this is that chatbots with high granularity for a given topic (e.g., greeting utterances, requests for more detail, questions regarding a particular product) are required to recognize and respond to a high number of intents for that topic. Typically, each of those intents and associated responses must be stored within the chatbot's memory, increasing the storage requirements for the chatbot.

High granularity also increases chatbot resource requirements because chatbots must have access to the hardware and software resources to quickly match the content of an utterance with an intent stored within the chatbot's memory. As the number and similarity of the intents stored in the chatbot's memory increases, the difficulty of this task also increases.

One common way for chatbots to recognize the intent of an utterance (i.e., to match the content of an utterance to a stored intent) is to analyze the content of the utterance using a series of classifiers. In some instances, each intent that a chatbot is configured to recognize may be associated with a unique classifier. These classifiers may take the form of a neural network that accepts the content of the utterance as an input and outputs a predicted likelihood that the intent associated with the classifier matches the intent of the utterance.

For example, a chatbot that is configured to differentiate between friendly greetings and hostile greetings may operate a friendly greeting classifier and a hostile-greeting classifier. When that chatbot receives a greeting utterance (or, in some instances, any utterance), the chatbot may input the content of that utterance into both the friendly greeting classifier and the hostile-greeting classifier. If, for example, the content of an utterance states “Hey buddy,” the friendly greeting classifier may output a likelihood of 90%, signifying a 90% confidence that the utterance contains a friendly greeting (i.e., has a “friendly greeting” intent). On the other hand, the hostile-greeting classifier may output a likelihood of 15%, signifying only a 15% confidence that the utterance contains a hostile greeting. However, an utterance that states “get lost” may result in a 5% output from both a friendly greeting classifier and an unfriendly greeting classifier.

Further levels of granularity may further increase the number of classifiers necessary to recognize intents within utterances. For example, rather than simply detecting a “friendly greeting” intent, a chatbot may be capable of detecting whether a greeting is friendly or hostile and whether a greeting is formal or informal. In some such instances, a chatbot may operate a friendly formal classifier, a friendly informal classifier, a hostile formal classifier, and a hostile informal classifier. If, for example, the chatbot were also able to detect whether an utterance included a time-of-day-based greeting (e.g., good afternoon, good evening) or not, the combination of classifiers may increase significantly. For example, the chatbot may operate a friendly formal morning classifier, a hostile formal evening classifier, a friendly formal afternoon classifier, a hostile informal without a time-of-day indication classifier, and so on. In this example, the chatbot may operate 16 separate neural networks solely to enable the chatbot to be able to recognize the type of greeting with which a user started a conversation. While this may be useful, for example, when attempting to quickly identify users who may require extra attention (e.g., frustrated customers), the resources requirements of training these classifiers may be overly burdensome, and thus may not be desirable in many situations.

As illustrated, in some instances the number of classifiers required to accurately determine the intent of a message may increase exponentially as the granularity of recognized intents increases. However, in some instances the number of classifiers necessary may be reduced by inputting the content of an utterance through a chain of classifiers. The outputs of the classifiers could then be considered together to determine the intent properties of the message. While this may reduce the resources necessary to operate a chatbot in many instances, the number of classifiers necessary to operate chatbots with very high granularity can still be very high.

The amount of topics a chatbot is expected to be able to discuss can also significantly increase the amount of resources necessary to operate a chatbot. For example, in addition to the intents that are associated with greetings, a chatbot for a large retail establishment may be expected to respond to questions about store hours, returns, shipment tracking, product information, account information, employment opportunities, charge disputes, and others. In some use cases, each of these topics may contain many intents that a chatbot would be expected to recognize and respond to. A chatbot that serves as patient intake for a large hospital, on the other hand, may be expected to converse regarding a patient's symptoms and have hundreds of topics (each with many intents) for various potential patient conditions. A chatbot for a large company that answers questions about employee benefits and services may be expected to answer questions about salary increases, health insurance, vacation accrual, disability benefits, employee discounts, and others. In each of these examples, the number of topics a chatbot may be expected to converse may be very high, and the number of potential intents a message utterance could be expected to recognize for each topic may be equally high or higher.

Thus, the complexity and operating resources necessary for many chatbots may be significantly high. However, chatbot complexity and operating resources can grow far larger if the chatbot is not designed (sometimes referred to herein as “trained”) with sufficiently precise granularity. For the purpose of this disclosure, a chatbot may be considered to have been designed with imprecise granularity if that chatbot is capable of differentiating between more utterance intents than is desired by the designers or operators of the chatbot. For example, a chatbot may be operated by an online retail store to answer customer's questions about return policies. This chatbot may therefore be required to differentiate between many specific intents regarding product returns (e.g., intents relating to the time period during which returns are accepted, intents related to returns without a receipt, intents related to a product arriving damaged, and others). The chatbot may, as a result, operate store many intents and chatbot responses regarding product returns in storage that is accessible by the chatbot. The chatbot may also operate a large number of intent classifiers to recognize and differentiate between the intents in the messages received by the chatbot and associated with product returns.

In other words, the chatbot may have a very high granularity with topics associated with product returns. However, while the chatbot may have the capability to answer some questions about product pricing, the chatbot may be designed to give only very general pricing information and provide a link to a web page with pricing policies. For this reason, it may be desired for the chatbot to have low granularity with respect to pricing topics. For example, the online retail establishment may accept the chatbot responding to messages asking about future sales with the same reply with which the chatbot may respond to messages asking about current rebates and other messages asking about volume discounts. In other words, the chatbot may not be required to differentiate between many intents associated with pricing topics. Rather, it may be sufficient for the chatbot to simply recognize that a message utterance contains an intent to inquire about present pricing, inquire about future pricing, or inquire about a pricing dispute, rather than differentiating between, for example, hundreds of individual intents related to present pricing.

Because the amount of resources required to operate a chatbot can increase drastically as the granularity of the chatbot increases, designing a chatbot with high granularity only on topics that the chatbot is expected to be able to converse with specificity can result in significant resource savings. In other words, designing a chatbot with very precise granularity (sometimes referred to herein simply as precisely designing a chatbot or designing a chatbot with high precision) significantly reduce the amount of storage and processing resources required to operate a chatbot.

However, precisely designing a chatbot (i.e., designing a chatbot with high granularity on topics for which high granularity is desired and low granularity on topics for which low granularity is desired) can be a very time-consuming activity. The typical process for training a chatbot, for example, requires that the individuals for whom the chatbot is being designed (e.g., a human-resources representative of a company designing a chatbot to respond to dental-plan questions) spend a significant amount of time manually planning the granularity for the chatbot and overseeing the development process to increase the likelihood that the chatbot is not imprecisely trained. However, these individuals (sometimes referred to herein as “chatbot owners”) typically do not have the necessary background in software design to create, program, and adjust a chatbot, and thus chatbot owners often employ chatbot developers to effectuate the design planned by the chatbot owners.

For example, a typical early step in the process of training a chatbot includes developing a list of message intents the chatbot will be expected to recognize and respond to. In many use cases, this involves a person manually attempting to think of and record (e.g., write down) every such intent. Because chatbot owners typically have the best understanding of the intended granularity of the chatbot, it often is most efficient for chatbot owners to be involved with the creation of the list. However, manually creating this list can involve more time than chatbot owners have available, and thus chatbot owners may sometimes employ chatbot developers to create drafts of intent lists that are reviewed and altered by chatbot owners and chatbot developers iteratively. This iterative process itself can take a significant amount of time, resulting in lots of time lost for chatbot owners (who may be high-ranking individuals in a chatbot-owner company) and lots of time charged by chatbot developers (who may, due to their level of expertise, charge a high hourly rate). Thus, this iterative process can significantly increase development expense of a chatbot.

For this reason, one alternative method is to use a machine-learning system to analyze historical data to develop a list of intents. For example, one or more neural networks could perform natural language processing on recordings or transcripts of conversations held between end users (e.g., customers or employees of the chatbot owner) and the personnel the chatbot is intending to imitate (e.g., customer-service representatives or human-resource representatives). Such a machine-learning system may, for example, analyze the voice recordings of all calls between end users and a customer-service department and identify an intent in each end-user message. The resulting list may then be made available to chatbot owners and chatbot developers (sometimes referred to herein collectively or alternatively as “chatbot trainers”) for review. However, while this process may reduce the amount of time necessary to create an initial intent list, the resulting initial intent list may be far too specific (e.g., a unique intent may be created for each unique end-user message) or far too general (e.g., end-user messages discussing unique topics or asking unrelated questions may be combined into very broad, cumbersome intents). Thus, the initial intent list typically must be thoroughly reviewed and edited by chatbot trainers. This is typically a manual process, which involves a large investment of time. This is often exacerbated because the initial intent list is typically disorganized, repetitive, and very difficult to review.

For these reasons, developing an intent list with precise granularity for a new chatbot can be significantly expensive and time consuming whether chatbot owners do so completely manually, iterate with chatbot developers, or employ machine-learning systems to develop initial intent lists. However, not performing this process thoroughly may result in a chatbot that is more expensive to operate (because it has too many intents and responses to store and process), too complicated to use (because it takes too long for a user to find the question that returns the sought-for answer), or that is insufficient to serve its purpose (because it does not have enough intents to recognize and answer user questions with sufficient specificity).

Once an intent list with the appropriate granularity is developed, the next step of training the chatbot typically involves developing logic flows for the eventual conversations the chatbot will have with end users. In the most basic of use cases, this simply involves associating each intent from the intent list with a chatbot response. In other words, for each intent in the list, a chatbot owner or chatbot developer may create a message that the chatbot would send to an end user when the chatbot recognizes that particular intent in an end-user message. For example, if an intent list included a “gratitude” intent, the chatbot owner or developer may create a chatbot response that states “You are welcome!” and associate it with the “gratitude” intent.

In some use cases, even this basic process can be complicated, because chatbot responses must be created taking into account the expected user utterances that would apply to each intent. Otherwise, the original purpose of some intents in the intent lists may not be met by the chatbot responses. However, because the process of creating an intent list (or editing an initially created intent list) is typically manual, it can also be quite error prone. This can result in, for example, mislabeled intents or duplicate intents. The errors in the intent list can then impact the ability of a chatbot trainer to accurately connect chatbot responses with the intents in an intent list. For example, two intents that are intended to be treated separately may have responses that are too similar to be useful if a chatbot developer does not remember that the first intent exists when creating a response for the second intent. In another example, the responses to two intents may become mixed up if a chatbot owner mistakenly believes that a first intent is intending to accomplish the purpose of a second intent when creating a response, and vice versa. As a result, user questions that are intended to evoke the response “I'm sorry, I am unable to assist you with that, please contact customer support” may actually evoke the response “Sure, please take a look at this support document,” with a link to a document with no helpful information.

Further, the process of developing chatbot logic flows can be more complicated when a chatbot is expected to do more than simply answer individual questions. For example, in some use cases a chatbot may respond to a user utterance by asking a series of questions, after each of which the user may respond with information. The chatbot's overall answer to the original user utterance may depend on the information in each user response. In such a use case, the logic flows for the chatbot may resemble many complicated if-then flow charts. These charts may be difficult to create manually, and may require the input of both the chatbot owner, who may understand the purpose and intended capabilities of the chatbot, and the chatbot developer, who may be capable of programming the if-then logic into the chatbot. For reasons similar to the reasons associated with creating an intent list, this can result in an iterative process with high development costs.

Once the list of intents is developed, the chatbot can be trained to recognize the intents within a user utterance. As discussed previously, this typically occurs by training many classifiers, each of which analyzes an input utterance and determines the confidence that the utterance matches the intent associated with the particular classifier. Training a classifier typically requires training data, which may either be historical data (e.g., transcripts of previous customer-service interactions) or hypothetical data that is manually created by a chatbot trainer (i.e., a chatbot owner or chatbot developer). Training data for a particular classifier may take the form of a set of utterances and a record of whether the utterance contains the intent for which the classifier is being trained. For example, training data for a classifier that is being trained to detect whether a customer is asking for the nearest store location may include thousands of user utterances (historical or hypothetical) and, for each utterance, whether that utterance is asking for the location of the nearest store.

Training data for the chatbot classifiers, regardless of whether the data is historical or hypothetical, is typically voluminous. Even locating/creating and preparing the training data for a few classifiers can be a burden on some chatbot owners. Further, as was also discussed previously, the number of classifiers that are necessary to operate a chatbot typically increases as the number of intents the chatbot can recognize increases. For these reasons, training classifiers for intents that are not necessary or desired for a chatbot to recognize can waste significant development and personnel resources.

For all of the above reasons, it is clear that solutions to precisely design the granularity of a chatbot are of tremendous importance to efforts to limit the costs of developing and operating a chatbot. However, as has been discussed, the personnel and financial investments necessary to precisely design a chatbot can also be overly burdensome, sometimes to the point of being completely prohibitive. For these reasons, efficient solutions by which the granularity of chatbots can be precisely designed are desired.

Some embodiments of the present disclosure present methods and systems by which a chatbot can be precisely designed while limiting the amount of investment required by a chatbot trainer. Some embodiments of the present disclosure accomplish this by, for example, analyzing a set of historical conversation data (e.g., recordings of customer-service calls) and categorizing them hierarchically based on the content of the utterances.

For example, a chatbot-training system may perform natural-language analysis on a large set of utterances, converting them to structured data. The system may then organize the utterances in those structured data by topic. The utterance “when does the store close” may be organized in a low-level group titled “store hours,” and the utterance “what is the store's address” may be organized in a low-level group titled “store location.” However, both of those low-level groups may be themselves located within a higher-level group titled “store information.” In some embodiments, the low-level groups may themselves be potential intents that the chatbot-training system proposes. In some embodiments, the low-level groups may each contain a set of one or more specific intents related to that group. For this reason, the hierarchical cluster relationships can be treated as a corpus of intents that are organized hierarchically. Low-level groups in the corpus may represent more specific, granular intents (e.g., a question regarding a person's health-insurance copay for a specialist visit), whereas high-level groups in the corpus may represent broad, generalized intents (e.g., all questions about health-insurance plans).

In some embodiments of the present disclosure, once the chatbot-training system creates a hierarchical corpus for the utterances of the historical data, the historical clusters can be presented to a chatbot trainer for use in customizing the intent hierarchy. As previously discussed, however, in many instances a chatbot owner may not have the technical expertise to modify the chatbot, and a chatbot developer may not have the use-case knowledge necessary to understand what customizations to the intent hierarchy may be necessary. Some embodiments of the present disclosure address this by eliciting customizations from a chatbot trainer using a series of specific questions related to the relationships of different clusters in the intent hierarchy.

For example, a chatbot-training system may choose two related intents in the hierarchy and present a chatbot trainer with a representative utterance associated with each intent. The chatbot trainer may then be given the opportunity to enter or select responses that the chatbot would be expected to provide to each utterance. If the chatbot trainer chooses the same response for each utterance, the two intents may be merged into a single, broader intent (sometimes referred to herein as an intent group). This may also reduce the chatbot granularity, as only the single broad intent would be stored and analyzed by the chatbot in operation, rather than two more-specific intents. The chatbot trainer may also have the opportunity to enter different responses for each utterance, which may result in the intents for each utterance remaining separate. Further, the chatbot trainer may also have the opportunity to delete the intent related to the utterance, which may be useful in instances in which the intent hierarchy contains topics that the chatbot is not intended to be able to discuss.

This process for customizing the granularity of the intent list for a chatbot may be beneficial because the individuals to whom the utterances are presented need very little technical expertise in order to assist with the customization. Rather, as long as the individuals have sufficient knowledge of the chatbot's intended granularity, are able to read prompts on a display and click a corresponding key/button, the individuals could customize the intent list in this fashion. This may enable several employees of the chatbot owner to work together to more quickly customize the intent list, and to do so without relying on expensive chatbot-developer resources.

Some embodiments of the present disclosure also elicit feedback from chatbot trainers to automatically create logic flows for the chatbot. For example, in some embodiments a chatbot development system may create logic flows by staging training conversations with a chatbot trainer. The chatbot trainer may choose from a list of stored utterances that were analyzed by the chatbot development system when constructing an intent hierarchy. Selecting a greeting, for example, may send a display a greeting utterance in a training conversation window. Upon detecting the greeting intent, the chatbot development system may then either propose a response (e.g., a reply greeting utterance) or the chatbot trainer may type a response that the chatbot would be expected to provide a user. The chatbot trainer may then select another stored utterance, such as a question regarding available insurance plans. Upon matching the utterance with the intent in the customized hierarchy, the chatbot-training system may be able to determine an appropriate response, such as asking the user for more information (e.g., “In what country do you work?”). As before, if the chatbot-training system is unable to determine an appropriate response, the chatbot trainer may type a response or choose a response from a list of suggested responses provided by the chatbot-training system. This list of suggested responses may be based, for example, on the analysis performed on the historical data that was used to create the intent hierarchy.

This process may continue until the training conversation has reached a natural completion point (e.g., when all of the utterances proposed by the chatbot trainer have been addressed), at which point the chatbot development system may connect the intents associated with the utterances entered by the chatbot trainer and the responses provided by the chatbot development system. The chatbot development system may further connect the series of intents and responses in a logic flow, and save that logic flow to the chatbot's storage.

In some embodiments, the chatbot development system may present a graphical representation of the created logic flow to the chatbot trainer for confirmation. This graphical representation may also include any new utterances created by the conversation (e.g., chatbot responses) and new intents that may have been added in the conversation. Further, the graphical representation may include a note of the intents that were associated with each utterance in the conversation, as well as those intents' location on the customized intent hierarchy. The chatbot trainer may then make alterations if needed (e.g., alter saved chatbot responses, merge new intents into existing intents, and move intents to different locations on the intent hierarchy), or confirm the logic flow.

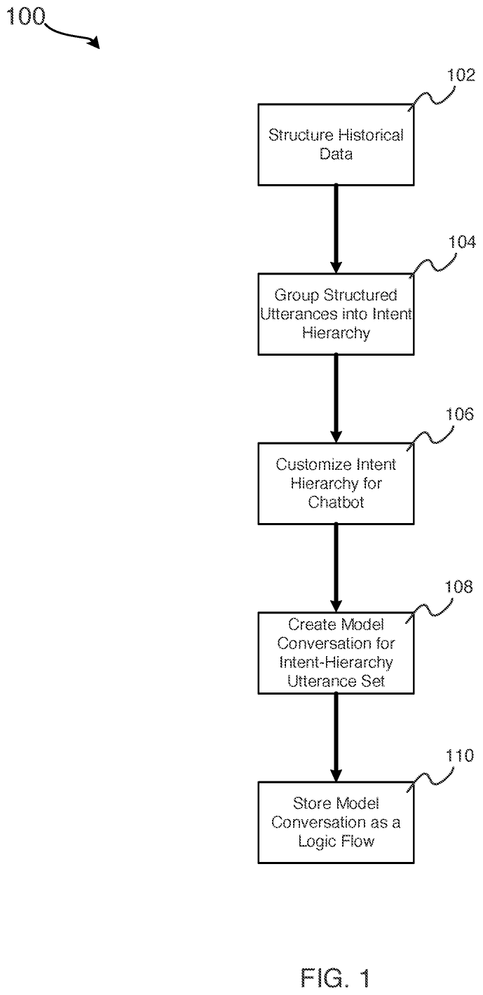

FIG. 1 illustrates an example method 100 of training a chatbot with precise granularity according to embodiments of the present disclosure. Method 100 may be performed by, for example, a chatbot-training system that includes a machine-learning system such as one or more neural networks. Method 100 begins with block 102, in which a chatbot-training system analyzes unstructured historical data and converts it to computer-readable structured data. In some embodiments, for example, the chatbot-training system may obtain historical conversation data from the chatbot owner, obtain historical conversation data from a third-party source, or may provide historical data owned by a chatbot developer that is providing the services of the chatbot-training system. For example, the chatbot-training system may be training a chatbot to discuss refund disputes with customers, and the chatbot owner may provide previous conversations between customers of the chatbot owner and customer-service representatives. In some embodiments, the historical data may be video or audio recordings of previous conversations, transcripts between of those recordings, or message logs of text conversations.

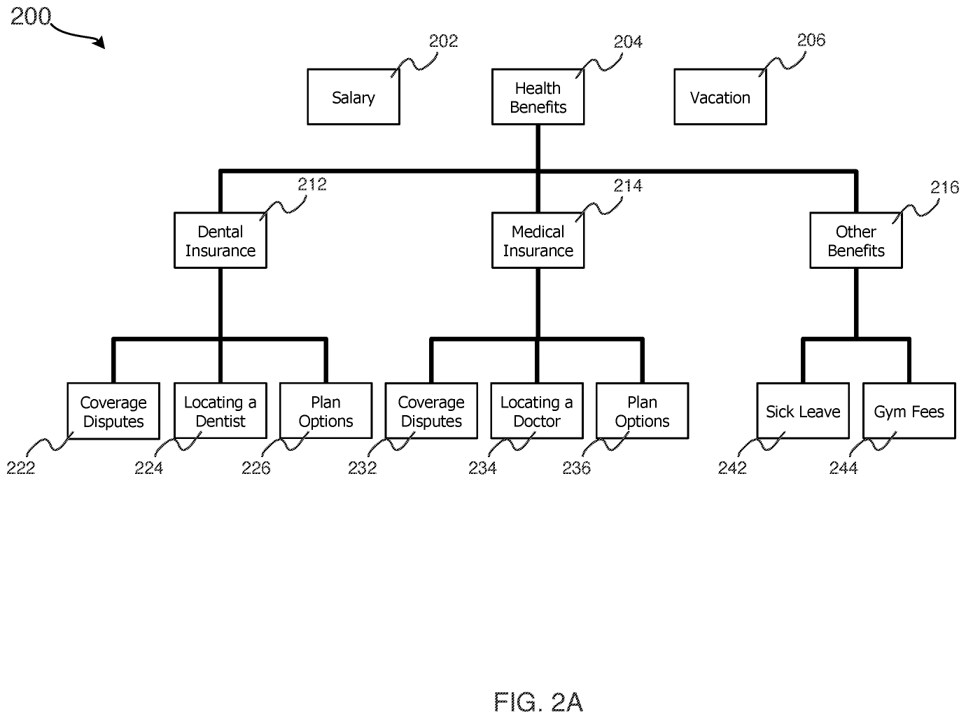

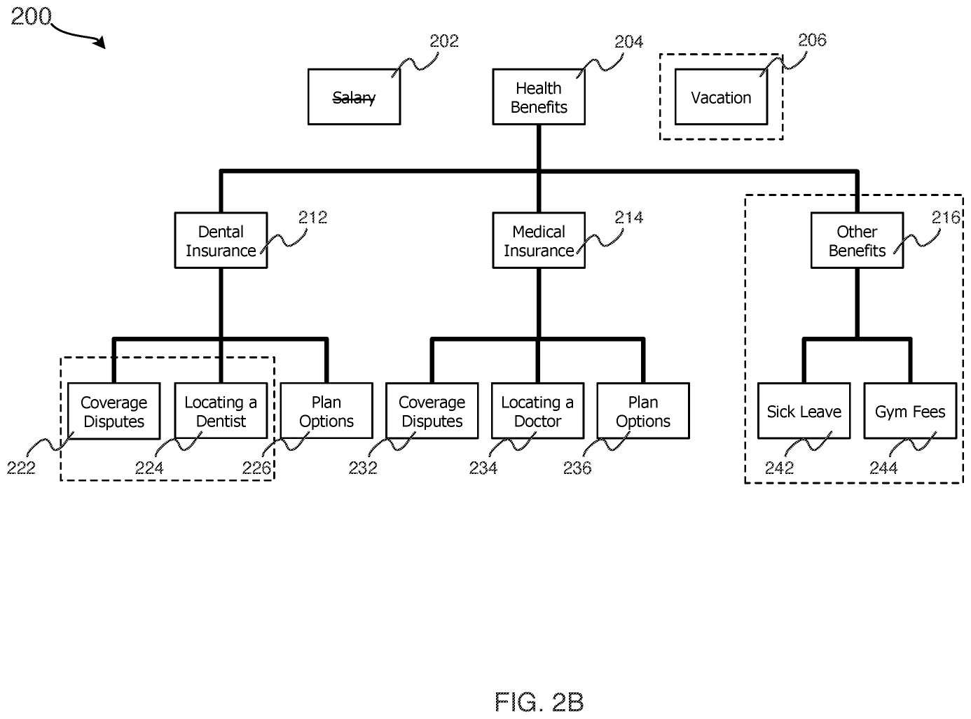

Upon structuring the historical data into a computer-readable format, the chatbot-training system analyzes the utterances in the structured-data corpus and creates, in block 104, a hierarchical cluster organization of the intents (sometimes referred to herein as an “intent hierarchy”) identified within those utterances. Such an intent hierarchy may be visualized as a branching chart that contains, at the most general end (e.g., the top) a list of macro topics that are found in the body of utterances. For example, the chatbot-training system may identify the macro topic “returns” and the intent hierarchy may place the subtopics “replacements” and “refunds” beneath the macro topic. Any utterance that generally mentions (e.g., asks about, requests) a replacement may be labeled with a “replacements” intent, whereas any utterance that generally mentions “refunds” may be labeled with a “refunds” intent. A graphical representation of an intent hierarchy is provided in FIG. 2A.

In some embodiments, the intent hierarchy created in block 104 may contain clusters of intents that are associated with common utterances that do not directly relate to the subject matter for which the a chatbot is being trained. Utterances providing greetings, expressing gratitude, apologizing, and saying goodbye all may be common in typical conversation with a chatbot. For example, chatbots being trained to discuss product returns, information-technology troubleshooting (sometimes referred to herein as “IT troubleshooting”), self-help medical questions, or others, may be expected to respond to these common utterance and even provide these utterances in responses to users. However, these utterances, and the intents associated with them, may not directly relate to product returns, IT troubleshooting, or self-help medical questions. That said, including clusters of intents associated with these utterances in an intent hierarchy may enable the trained chatbot to more completely, convincingly, and politely respond to end-user questions and comments. For that reason, it may be beneficial to include the intents of these utterances in an intent hierarchy.

However, while it may be beneficial to include the intents of common utterances, it may not be necessary to spend time and resources analyzing historical data to identify the intents of those utterances. Rather, because these utterances are commonly used, their use is unlikely to differ between chatbots that field questions about, for example, human-resource questions and restaurant reservations. For this reason, it may be a waste of resources to create the intent clusters for these common utterances each time a chatbot is trained. In some embodiments, therefore, a chatbot-training system may provide a set of pre-analyzed, pre-grouped intent clusters associated with common utterances that could be used in a variety of intent hierarchies for a variety of chatbots. In some of these embodiments, these pre-grouped intent clusters may be added to the intent hierarchy in block 104, or may be kept as a separate intent hierarchy. This may enable the chatbot-training system to only analyze those utterances in historical data that relate to the subject matter for which the chatbot is being trained.

In some embodiments, block 104 may also include analyzing the created intent hierarchy for a gauge of the quality of clusters and hierarchical trees therein. For example, silhouette interpretation may be performed to identify preliminary issues with the clusters of the created intent hierarchy. In silhouette interpretation, a silhouette value may be calculated for each intent in a cluster. This silhouette value may be a measure of how similar that intent is to other intents in its cluster compared to how similar that intent is to intents in other clusters. A high silhouette value may indicate that an intent is well related to the other intents in its own cluster and poorly related to intents in other clusters. If, during silhouette interpretation, a cluster with one or more intents that have low silhouette values is identified, the chatbot-training system may attempt to identify one or more intents within that cluster to relocate. For example, the chatbot-training system may first relocate the intent with the lowest silhouette value to a different cluster (e.g., the cluster of intents with which the relocated intent has a high amount in common). If the intents of the cluster still have low silhouette values after this intent is relocated, the chatbot-training system may relocate the intent next-lowest silhouette value.

In a further example, hierarchical balancing may be performed to identify preliminary issues with the hierarchical organization of the created intent hierarchy. In hierarchical balancing, one or more intents may be analyzed to identify intents that are far more specific or far more general than other intents on the hierarchical level. As used herein, a hierarchical level may refer to the number of parents between an intent and the highest intent in the hierarchy (i.e., the intent with no parents). Sibling intents, therefore are on the same hierarchical level, because they share the same parent. Similarly, first-cousin intents are also on the same hierarchical level (as used herein, “first-cousin intents,” sometimes simplified to “cousin intents” refers to the children of one intent as related to the children of that intent's sibling). In hierarchical balancing, a particular intent may be compared to other intents on the same hierarchical level to determine whether those intents have the same specificity as that particular intent. If, for example, a particular intent asks a very specific question, but a first-cousin intent of the particular intent asks a very general question about a very broad topic, the hierarchy may be out of balance. If the hierarchy is out of balance, the chatbot-training system may review the created intent hierarchy to determine, for example, if further intent categories are necessary.

Once an intent hierarchy is created, the chatbot-training system may customize the intent hierarchy in block 106 for the chatbot being trained. This may include identifying sets of intents in a cluster that are more specific than necessary for the needs of the chatbot, and merging those sets of intents into a single intent (sometimes referred to with respect to the intent hierarchy as the “intent group”). Referring back to the previous example, an intent hierarchy may include a macro intent “returns” along with more specific intents “refunds” and “replacements” beneath it. However, if a chatbot owner requires that the chatbot only respond to utterances regarding returns generally, rather than providing a unique response to utterances about refunds and a second unique response to utterances about replacements, the “refunds” and “replacements” intents could be merged into the “returns” intent, which could be graphically displayed by deleting the “refunds” and “replacement” subtopics or otherwise visually grouping them with the “returns” macro topic. A graphical representation of merging two intents in an intent hierarchy is provided in FIG. 2B.

In some embodiments, customizing and intent hierarchy for a chatbot being trained may include eliciting feedback of a chatbot trainer in a way that does not require the chatbot trainer be technically proficient in making adjustments to the chatbot or the intent hierarchy directly. For example, as part of block 106, the chatbot may select an example utterance from the historical data that was structured in block 102 and that has an associated intent in the intent hierarchy. That example utterance could be presented to an owner of the chatbot in a graphical user interface and request the chatbot owner to provide a response that the chatbot should give in response to the utterance. The chatbot-training system may then associate the response with the intent that was associated with the utterance. Because of this association, the trained chatbot may provide that response anytime an end user sends an utterance to the chatbot that the chatbot recognizes as having that intent.

After that association is created, the chatbot-training system may ask the chatbot owner whether that same response should be provided to by the chatbot for any other intents. Once again continuing the previous example, if the original utterance that the chatbot-training system presented to the user was associated with the “refunds” intent, the chatbot-training system may select an utterance from the “replacements” intent and present it to the chatbot owner. The chatbot-training system may ask the chatbot owner whether the trained chatbot should also use the same response to answer that utterance.

If the chatbot owner says “yes,” the replacements and refunds intents could be merged in a customized intent hierarchy. In some embodiments, if a chatbot trained using the list of intents in this customized intent hierarchy were to receive any utterance “returns” intent, it may provide the same response. In some other embodiments, the “refunds” and “intents” intents may be merged, but may remain separate from (though a subset of) the more general “returns” intent. In these embodiments, the same response may be provided in response to any utterance that matches either the “refunds” or “replacements” intents, but a separate, more general response may be provided in response to any utterance that matches the “returns” intent.

If, on the other hand, the chatbot owner informs the chatbot-training system that the utterance associated with the “replacements” intent should not be used to respond to an utterance associated with the “refunds” intent, the two intents may not be merged. In these embodiments, the chatbot-training system may then request a new response that the trained chatbot should provide in response to the second utterance that is associated with the “replacements” intent, which would then be associated with that intent.

The process described with respect to block 106, or a similar process, may be repeated for additional intents in the intent hierarchies until the hierarchy is fully customized. In some embodiments, this may also include customizing intent clusters that are associated with common utterances, whether those clusters are within the same intent hierarchy or a pre-prepared common-utterances intent hierarchy.

Once the customized intent hierarchy is created, the chatbot-training system may create, in block 108, a model conversation for a set of utterances from the customized intent hierarchy. This model conversation may be created with input from a chatbot trainer to increase the likelihood that conversations with the chatbot that include those utterances follow the flow that the chatbot trainer is intending.

In some embodiments, creating the model conversation may involve selecting a first utterance from the customized intent hierarchy. In some embodiments, this selection may take the form of requesting chatbot trainer to pick an utterance from a list of utterances associated with an intent. For example, a chatbot trainer may inform the chatbot-training system that the chatbot trainer wishes to create a model conversation regarding an “asking for the status of a refund” intent. The chatbot-training system may then propose a list of utterances that are associated with this intent in the customized intent hierarchy. In some embodiments, the chatbot trainer may also search for a specific utterance, which, if found in the customized intent hierarchy, may be selected. If, on the other hand, the specific utterance is not found in the customized intent hierarchy, the chatbot trainer may add it to the customized intent hierarchy and select an intent in the hierarchy with which the intent should be associated. In some embodiments, other methods of selecting an utterance may be possible.

When the utterance is selected, the chatbot-training system may propose a response to the utterance, or the chatbot trainer may provide a response. In some embodiments, several responses may be proposed/provided. For example, some user questions may require a stalling response (e.g., “please give me a few minutes to check this”), followed by an update response (e.g., “ok, the status of the refund is ‘pending’”). In some embodiments, multiple responses may be selected to reply to the original utterance, but they may not be delivered at the same time.

For example, if a chatbot trainer selects the question “what is the status of my refund?” as the first question, the chatbot-training system, chatbot trainer, or both may determine that a chatbot would need to ask multiple questions before that question could be answered. Thus, the responses “Will you please tell me the order number?” and “What is the Return ID for the refund?” may be selected, but the second response may be queued after the first response. For example, the responses may be configured such that the second response (“What is the Return ID for the refund?”) is not be sent to an end user after (1) the chatbot has provided the first response (“Will you please tell me the order number?”) and (2) the end user has provided an order number that the chatbot can verify.

The pattern in which multiple responses that apply to a single end-user utterance are delivered to an end user may vary based upon use case and the circumstances of the communication (e.g., previous intents in the conversation, previous responses provided to the user, purpose of the chatbot, data about the end user to which the chatbot has access, etc.). The configurations that make up these patterns may be referred to herein as “response conditions.” For example, in some embodiments a response may be selected to follow a prior response if a certain amount of time has passed. In these embodiments, a time-dependent response condition may be set. This may be beneficial to determine whether a user is still in the chat. For example, the chatbot response “[END USER NAME], are you still there?” may be select to follow a particular response, or all responses, if the user does not provide any utterances for a pre-determined amount of time (e.g., 5 minutes). In some embodiments, an if-then-else response condition may be set, in which one or more responses is queued behind a prior response, and a single queued response may be selected based on the end-user's utterance provided after the prior response. For example, if a first response provided by a chatbot were “Do you have your order number?,” the responses “What is the order number?” and “Ok, let me search for it in your account” may both be queued behind the first response with an if-then-else response condition. If the end user were to reply “Yes” to the first response, the chatbot may select “What is the order number?” as the follow-up response. However, if the end user were to reply “No,” the chatbot may select “Ok, let me search for it in your account” as the follow-up response. These response conditions are provided as examples; other response conditions consistent with the embodiments of this disclosure are also contemplated.

Some embodiments, the response condition(s) for a response or set of responses may be set by the chatbot trainer in a graphical user interface or suggested by the chatbot-training system. In some embodiments, the chatbot-training system may not present technical response conditions to the chatbot trainer, but may ask the chatbot trainer a series of questions, the answers to which may allow the chatbot to derive the response conditions. This may make it easier for a non-technical chatbot owner to create model conversations with the chatbot-training system. For example, the chatbot-training system may ask the chatbot trainer whether multiple responses would be required to fully address a user utterance, and, if yes, whether one of those responses should come before the other, and, if yes, whether a subsequent response would always need to be asked, or only sometimes, et cetera.

At some point in the process, the chatbot trainer and the chatbot-training system may decide that the model conversation is complete. For example, the chatbot trainer may be able to click a “conversation complete” button on a graphical user interface. A chatbot-training system may also ask a chatbot trainer whether the conversation is complete if the chatbot-training system is not able to find a response utterance to suggest to the chatbot trainer, or if the conversation contains utterances associated with the farewell content. Once the model conversation is complete, the chatbot trainer may have the opportunity to review the conversation and confirm its properties (e.g., the order of the utterances, new utterances and their associated intents, new intents, response conditions, etc.).

After the model conversation is created, the chatbot-training system may store the model conversation (including any new intents, response conditions, etc.) as a logic flow in block 110 for the chatbot's use. The chatbot, when trained, may follow the logic flow when it detects an intent that is associated both with the logic flow and with a received end-user utterance.

For ease of understanding, FIG. 2A illustrates an example graphical representation of an intent hierarchy 200. Intent hierarchy 200 is meant solely as an example to aid in comprehension. For that reason, intent hierarchy 200 may be less detailed than a graphical representation of an intent hierarchy for an actual chatbot being trained at runtime. In some real-world embodiments, for example, an intent hierarchy may have hundreds or thousands of intents in a hierarchy, and the hierarchical relationship may be significantly more complicated than is presented in intent hierarchy 200.

Further, in some embodiments a chatbot-training system may not actually create a graphical representation of an intent hierarchy similar to intent hierarchy 200. In those embodiments the chatbot-training system may store the relationship information that would be displayed by the hierarchy in other formats. For example, in some embodiments a chatbot trainer may not wish to or be able to view the intent hierarchy. In those embodiments, there may be no need to create a graphical format and the chatbot-training system may store the intent hierarchy in a format that is more convenient for storage, retrieval, reading, modification, or others.

Intent hierarchy 200 discloses, as an example, groups of intents associated with a human-resources chatbot that may be trained to field employee questions about employee benefits. This use case is meant only as an example; the same type of intent hierarchy could be created for other use cases, such as a chatbot to discuss product returns, a chatbot to discuss all product issues on a retailer's website, a reservation chatbot, or others. Further, while intent hierarchy 200 does not, as illustrated, disclose intents associated with common utterances (e.g., utterances that are common in conversation with a chatbot or end user but that do not pertain directly to the subject matter for which the chatbot is being trained), in some embodiments a similar intent hierarchy may contain separate groups for common utterances.

The intents within intent hierarchy 200 may sometimes be described herein relative to other intents within the hierarchy. For example, intents 212, 214, and 216 may all share a parent intent (health-benefits intent 204). For this reason, they may all be referred to as sibling intents. Further, dental-insurance intent 212 may have 3 immediate children intents (i.e., coverage-disputes intent 222, locating-a-dentist intent 224, and plan options 226). Intents 222, 224, and 226 may be referred to as “grandchildren intents” or “second-level-children intents” with respect to health-benefits intent 204.

Some groups of intents in intent hierarchy may be referred to herein as “intent clusters” (or “clusters of intents,” or even simply “clusters”). An intent cluster may refer to a group of intents that are hierarchically related under a single intent. For example, in intent hierarchy 200, all intents nested under health-benefits intent 204 may be referred to as an intent cluster (e.g., the “health-benefits intent cluster”). Similarly, all intents nested under dental-insurance intent 212 may also be referred to as an intent cluster (e.g., the “dental-insurance intent cluster”) that is nested within the health-benefits intent cluster. However, plan-options intent 226 and locating-a-doctor intent 234 may not be considered, by themselves, a cluster, because they do not share the same parent and their parents would not be in the cluster. However, dental-insurance 212, medical insurance 214, and intents 222 through 236 may all together be considered an intent cluster.

Intent hierarchy 200 discloses intents 202, 204, and 206. These intents may be broad categorizations of subject-matter topics that are found in the data (e.g., historical data from previous chat transcripts) that was analyzed to create the intent hierarchy. Salary intent 202 may contain, for example, all the intents associated with utterances about employee salary (e.g., questions about future earnings, questions about salary advances, questions about raises, statements that salaries are too low, etc.). Health-benefits intent 204 may contain, for example, all the intents associated with utterances about employee health benefits (e.g., questions about locating an in-network dentist, questions about changing insurance elections, questions about reimbursements for health equipment or gym fees, utterances providing an elected insurance plan, etc.). Vacation intent 206 may contain, for example, all the intents associated with employee vacation benefits (e.g., submission of vacation requests, inquiries regarding available vacation, inquiries regarding company-wide closures, requests for vacation to roll over into the next calendar year, etc.).

As illustrated in FIG. 2A, salary intent 202 and vacation intent 206 are depicted as single boxes. This is for the sake of comprehension, and is not necessarily intending to suggest that all intents associated with salary or vacation could or would be combined into a single intent. Rather, for the purposes of this discussion, it should be assumed that each of salary intent 202 and vacation intent 206 may have clusters nested within them similar to the clusters that are nested within health benefits 204.

Health-benefits intent 204 is depicted as having children intents 212, 214, and 216 and grandchildren intents 222 through 244. In some embodiments, each of intents 202 through 244 may have a set of historical utterances associated with it. These may be, for example, all the utterances from historical data that are identified by a chatbot-training system as associated with that intent. For example, all utterances in historical data that relate to dental-insurance plan options may be associated with plan-options intent 226 in intent hierarchy 200. Further, utterances that relate to dental insurance generally, but not specifically to coverage disputes, locating a dentist, or dental-insurance plan options may be associated with dental-insurance intent 212.

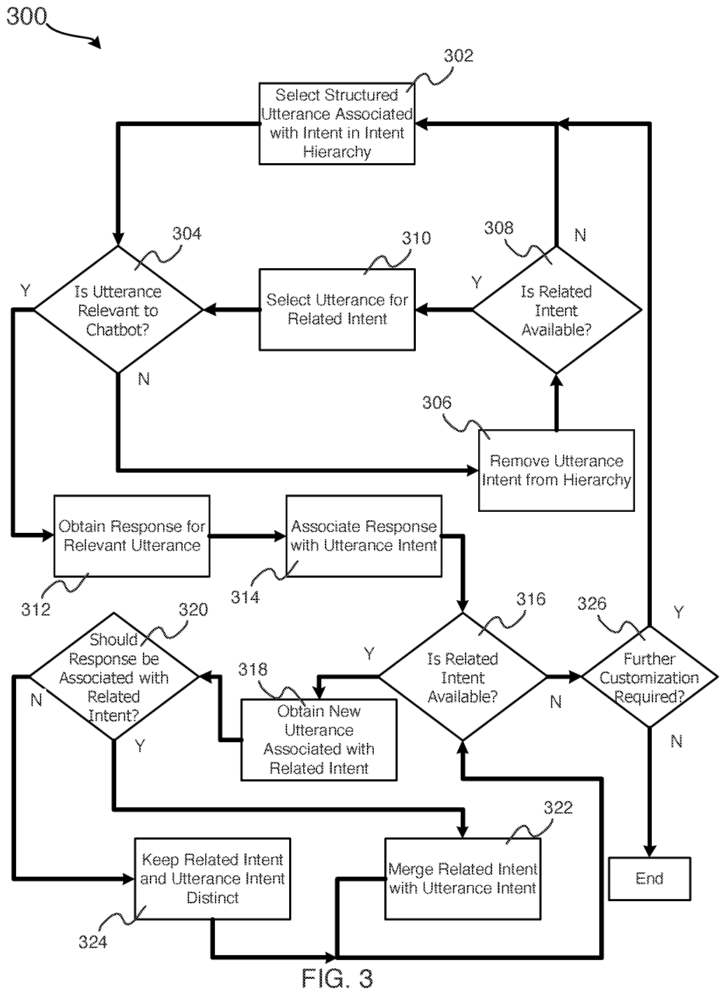

FIG. 2B illustrates a graphical representation of the effects of customization on intent-hierarchy 200. The customization of intent hierarchy 200 that is depicted in FIG. 2B may be the result of, for example, a chatbot-training system customizing intent hierarchy 200 through a process consistent with the present disclosure that incorporates chatbot-trainer feedback, such as block 106 of FIG. 1 and FIG. 3.

For example, intent hierarchy 200 may have been customized by a chatbot owner who, through a graphical user interface, answered questions proposed by a chatbot-training system to elicit feedback regarding the list of intents within the intent hierarchy. For example, a historical-data utterance associated with the coverage-disputes intent 222 may be presented to a chatbot owner along with a second historical-data utterance associated with the plan-options intent 226. The chatbot-training system may then ask the chatbot owner whether the chatbot would respond to those utterances with the same response, or whether two responses would be necessary to address the utterances. If the chatbot owner responds that two separate responses would be necessary, the coverage-disputes intent 222 and the plan-options intent 226 would not be merged. This result is illustrated in FIG. 2B.

However, the chatbot-training system may then present an utterance corresponding to the locating-a-dentist intent 224 together with the coverage-disputes intent 222, and ask the chatbot owner a similar question (e.g., “would the chatbot respond to these two utterances with the same response?”). If the chatbot owner response that a single response could be used to address both utterances, then coverage-disputes intent 222 and locating-a-dentist intent 224 would be merged, as represented in this example graphical representation by the dashed line surrounding the two intents. This customization may be beneficial for a chatbot that, for example, is expected to give very specific information to end users (e.g., employees) regarding their various dental-insurance plan options, but it only able to provide very basic information in response to end-user comments and questions regarding dental-insurance coverage disputes and locating a dentist. For example, the chatbot may be expected to provide a link to a “more information” page in response to any end-user question about the amount of dental expenses covered or about locating an in-network dentist, but may be expected to walk end users through all the details of their potential dental-insurance plans.

Continuing the example, after the coverage-disputes intent 222 and locating-a-dentist intent 224 were merged, the chatbot-training system may determine that there are no further sibling intents to merge (because the merged intent only has one sibling intent: plan-options intent 226). At that point, the chatbot-training system may then determine whether to merge the child or parent intents of the merged intent group. For example, the chatbot-training system may present the chatbot owner with a more general historical utterance associated with the more general dental-insurance intent 212, and ask the chatbot owner whether it would also be responded to in the same way as the utterances associated with the merged coverage-disputes intent 222 and locating-a-dentist intent 224. If the chatbot owner determines that separate responses would be required, the dental-insurance intent 212 would not be added to the merged intent group. This is the result illustrated in FIG. 2B.

The chatbot-training system may then present the end user with a few more utterances associated with the intents 212 and 222-226 with similar questions as before to confirm the resulting merges, or may explicitly ask the chatbot owner whether the merges are appropriate. Once the chatbot-training system has sufficient feedback from the chatbot owner supporting the decisions to merge intents 222 and 224, but not 212 or 226, the chatbot-training system may proceed to question the chatbot owner about other intents.

For example, the chatbot-training system may then present the user with an utterance associated with sick-leave intent 242 and an utterance associated with gym-fees intent 244. Going through a similar process discussed above, the chatbot owner may provide the chatbot-training system with enough feedback to determine that a merger of sick-leave intent 242 and gym-fees intent 244 would be proper. Further, the when the chatbot-training system presents the chatbot owner with an more general utterance associated with the more general other-benefits intent 216, the chatbot owner may respond that it also would be responded to in the same way as intents 242 and 244, and thus would be added to their merge group. This may be beneficial for a chatbot that is not expected by the chatbot owner to provide anything except general responses to all end-user utterances regarding “other benefits.”

Continuing the example, the chatbot-training system may also go through the above process (or a similar process) by presenting utterances associated with the medical-insurance intent 214, coverage-disputes intent 232, locating-a-doctor intent 234, and plan-options intent 236. As illustrated in FIG. 2B, the chatbot owner may wish for all these utterances to be responded to separately, and therefore the associated intents may not be merged. This may be beneficial, for example, if the chatbot being trained largely to answer end-user questions regarding medical-insurance issues, and thus would require distinct responses for utterances associated with the intents 214 and 232-236.

Further, the chatbot-training system may also go through the above process (or a similar process) by presenting utterances associated with the salary intent 202 and whatever child intents it may contain (not illustrated in FIG. 2B). Through this process, the chatbot owner may inform the chatbot-training system that each such utterance is not relevant to the chatbot being trained. For each such utterance, the chatbot-training system may delete the intent from the intent hierarchy. Once a sufficient amount of intents within the same cluster as the salary intent 202 are deleted, it may become clear that the chatbot being trained is not expected to provide any information in response to salary questions/comments, and the entire salary intent 202, along with all child intents (again, not illustrated in FIG. 2B) may be deleted. This may be useful for a chatbot that is expected to responds to end-user utterances regarding salary issues in the same way the chatbot is expected to respond to other irrelevant utterances (e.g., utterances regarding cafeteria hours, the user's favorite TV shows, and hot-air balloon rides). In the illustrated intent hierarchy 200, a single response may be appropriate for every end-user utterance regarding salary issues (for example, a response stating “I'm sorry, I don't have the capability to talk about that. Would you like to talk about your health or vacation benefits?” could be used).

Continuing the example, the chatbot-training system may also go through the above process (or a similar process) by presenting utterances associated with the vacation intent 206 and whatever child intents it may contain (not illustrated in FIG. 2B). However, unlike the salary intent, the chatbot owner may inform the chatbot-training system that each such utterance is relevant, but that the same response would be provided to all such utterances (for example, a response stating “I can only provide a limited amount of information regarding vacation benefits. To request vacation, please go to [URL X]. To request an advance on your vacation, please go to [URL Y]. For all other inquiries, please contact your manager” may be used).

Thus, as discussed in the previous paragraphs, the customizations shown to intent hierarchy 200 may create an intent list that is precisely suited for the chatbot being trained. In other words, the intent list of the chatbot may be granular on topics for which the chatbot is expected to provide detailed responses, but less granular (and thus requiring less storage and performance resources) on topics for which the chatbot is not expected to provide detailed responses. Specifically, the intent list associated with intent hierarchy 200 post customization may result in a chatbot that is capable of providing specific responses to specific questions regarding issues related to medical insurance and issues related to dental-insurance plan options. The chatbot may also be capable of providing a more general response regarding issues about either dental-insurance coverage disputes or locating a dentist. The chatbot may also be capable of proving a general response regarding general dental-insurance questions and issues, a general response regarding general medical insurance questions and issues, a general response regarding issues about other benefits, and a general response regarding questions and issues about vacation. Finally, the chatbot may not have any stored intents or responses regarding salary questions and issues, and may inform an end user that the chatbot is unable to discuss those questions and issues.

Further, the customization process described with respect to intent hierarchy 200 may be beneficial because it could be performed without requiring many iterations between a chatbot owner and chatbot developer. As illustrated, the intent-hierarchy is hierarchically organized into intent clusters based on the subjects matters of those intents and the associated utterances. Further, as a result of this hierarchical organization, the intents may be merged, not merged, or deleted based on simple, yes-no questions that a chatbot-training system could propose to one or more chatbot owners. Thus, intent hierarchy 200 may be customized by one or more chatbot owners who do not possess the technical knowledge necessary to make the customizations. This may not only save time because time-costly back-and-forth interactions between chatbot developers and chatbot owners may be unnecessary, but may also save cost because the chatbot-training system may not rely on high-hourly rate chatbot developers to make the customizations to the intent list.

FIG. 3 discloses an example intent-hierarchy customization method 300 that may be used to customize an intent list reflected by an intent hierarchy. Method 300 may be performed by a chatbot-training system and may be useful to customize an intent hierarchy such as intent hierarchy 200 in FIGS. 2A and 2B. As discussed previously, method 300 may be beneficial because it may be performed by the chatbot-training system using feedback received from a chatbot owner without the intervention of a chatbot developer. Further, the chatbot-training system could perform method 300 using the feedback given by many chatbot trainers over a period of time. For example, if a chatbot is being trained for a hospital, the chatbot may be trained to perform medical self-help chats or triage chats with patients. In these instances, the chatbot-training system may require the feedback of individuals who are both medically trained and who are aware of the chatbot's purpose. In this example, a team of doctors and nurses could all provide feedback to the chatbot-training system through method 300 when their section of the hospital is slow and they have available time. This may be more beneficial than typical methods of precisely customizing the granularity of a chatbot, as it is less likely to require a single individual (e.g., a doctor or hospital administrator) to create an intent list for or review an intent list created by a chatbot developer and participate in an iterative back-and-forth communication with the chatbot developer until the intent list is accurate.

Method 300 begins in block 302, in which a structured-data utterance associated with an intent in the intent hierarchy being customized is selected. This intent may sometimes referred to with respect to FIG. 3 as the “utterance intent.” In some embodiments, the selected utterance may have been previously converted from unstructured data to structured data, such as by a process similar to those discussed with respect to block 102 or a similar process that is consistent with the embodiments of this disclosure. This structured-data utterance may be selected, for example, based on the input of a chatbot trainer whose feedback is being used to customize the intent hierarchy. This structured-data utterance may also be selected based only on a decision of the chatbot-training system, which may, for example, select an utterance (or intent) at random, based on alphabetical order, based on number of intents in a cluster, or others.

Once the utterance is selected, the chatbot-training system determines, in block 304, whether it is relevant to the chatbot being trained by presenting the utterance to a chatbot trainer. If the chatbot trainer informs the chatbot-training system that the utterance is not relevant to the conversations the chatbot is expected to be able to hold, the chatbot-training system removes the utterance intent associated with that utterance from the hierarchy in block 306. The chatbot-training system then determines, in block 308, whether the intent hierarchy contains an intent that is related to the utterance intent that was removed in block 306. A related intent may be an intent that is of sufficient proximity in the hierarchical relationship. What is considered “sufficient proximity” may vary based on the embodiment and use case, but in some embodiments, for example, any sibling intents, child intents, or parent intents may be considered to be sufficiently proximate to the utterance intent. If the chatbot-training system determines that a related intent is not available, the chatbot-training system returns to block 202 to select a new structured utterance associated with a new utterance intent. However, if the chatbot-training system determines that a related intent is available, the chatbot-training system selects an utterance associated with that related intent in block 310. Once that utterance is selected, the chatbot-training system then returns to block 304 to determine whether that utterance is relevant to the chatbot being trained.

If, on the other hand, the chatbot-training system determines, in block 304, that the utterance IS relevant to the chatbot being trained, the chatbot-training system obtains a response for the utterance in block 312. In some embodiments, for example, the chatbot-training system may suggest a response based on an analysis of the structured utterances in historical data. In other embodiments, the chatbot-training system may prompt a chatbot trainer to provide a response for the relevant utterance.

Once the relevant utterance is obtained in block 312, the chatbot-training system associates the response with the utterance intent that is associated with the relevant utterance in block 314. In other words, the chatbot-training system trains the chatbot to provide the obtained response when the chatbot detects that it has received an utterance associated with the utterance intent.

The chatbot-training system then determines, in block 316, whether the intent hierarchy contains an intent that is related to the utterance intent. This determination may be performed using the same or similar analyses and thresholds to the determination in block 308. If the chatbot-training system determines that a related intent is available, the chatbot-training system obtains, in block 318, a new utterance that is associated with the related intent in the intent hierarchy.

Once the chatbot-training system obtains the utterance associated with the related intent, the chatbot-training system determines, in block 320, whether the response obtained in block 312 should also be associated with the related intent. This may be performed, for example, by displaying the new utterance obtained in block 318 to a chatbot trainer and asking the chatbot trainer whether the chatbot should also reply to the new utterance with the response obtained in block 312.

If the chatbot-training system determines (for example, based on chatbot-trainer feedback) that the response should be associated with the related intent, the chatbot-training system merges, in block 322, the related intent with the utterance intent in the intent hierarchy (and thus the resulting intent list) in block 314. The chatbot-training system then proceeds to block 316 to determine whether any further intents that are related to the utterance intent are available.

If, on the other hand, the chatbot-training system determines, in block 320, that the response should not be associated with the related intent, the chatbot-training system keeps the related intent and the utterance intent distinct in the intent hierarchy (and thus the resulting intent list) in block 324. The chatbot-training system then proceeds to block 316 to determine whether any further intents that are related to the utterance intent are available.

If the chatbot-training system determines, in block 316, that there are no related intents available, the chatbot-training system determines, in block 326, whether further customization to the intent hierarchy is required. Further customization may be required if there are additional intents available for which the chatbot-training system has not yet performed blocks 302 and 304, for example. In some embodiments, this may include intents that were determined to be related to the utterance intent in block 316 but were kept distinct from the utterance intent in block 324.

If the chatbot-training system determines that further customization is required, the chatbot-training system returns to block 302 to select a new structured utterance associated with a new utterance intent. The chatbot-training system will then continue method 300 to continue customizing the intent hierarchy. However, if the chatbot-training system determines in block 326 that further customization is not required, the chatbot-training system ends method 300, completing (at least for the time being), the customization of the intent hierarchy. At this point the customizations performed during method 300 may be presented to the chatbot trainer for confirmation. At this point the chatbot-training system may also use the customized intent hierarchy to create a precisely granular intent list for the chatbot.

In some embodiments, a customized intent hierarchy for a chatbot may be periodically analyzed once the chatbot has been deployed. For example, a chatbot-training system may continue to monitor a chatbot while the chatbot is communicating with end users. That chatbot-training system may collect that chatbot's real-world conversation data and add the utterances from that conversation data to the list of historical utterances with which the chatbot's intent hierarchy was originally trained. The chatbot-training system may then retrain the chatbot with the updated data (for example, by performing a process similar to blocks 104 of method 100). The chatbot-training system may also perform silhouette interpretation and hierarchical balancing on this updated intent hierarchy to identify potential issues with the updated hierarchy. If the chatbot-training system determines that the updated intent hierarchy is improved, it could incorporate it into the deployed chatbot.

After a chatbot-training system has developed a customized intent hierarchy and intent list for the chatbot, the chatbot-training system may then develop a set of logic flows for those intents (and the utterances associated therewith). In some embodiments of the present disclosure, a chatbot-training system may do this in a way that significantly reduces the input necessary from chatbot trainers. As discussed previously, typical chatbot logic flows are often created manually, which can require a significant time investment on the part of personnel who are aware of the chatbot's purpose (e.g., chatbot owners) and the personnel who are capable of programming the logic flow into the chatbot (e.g., chatbot developers). This can result in a significant number of back-and-fourth iterations between these two individuals, potentially costing a lot of time and money.

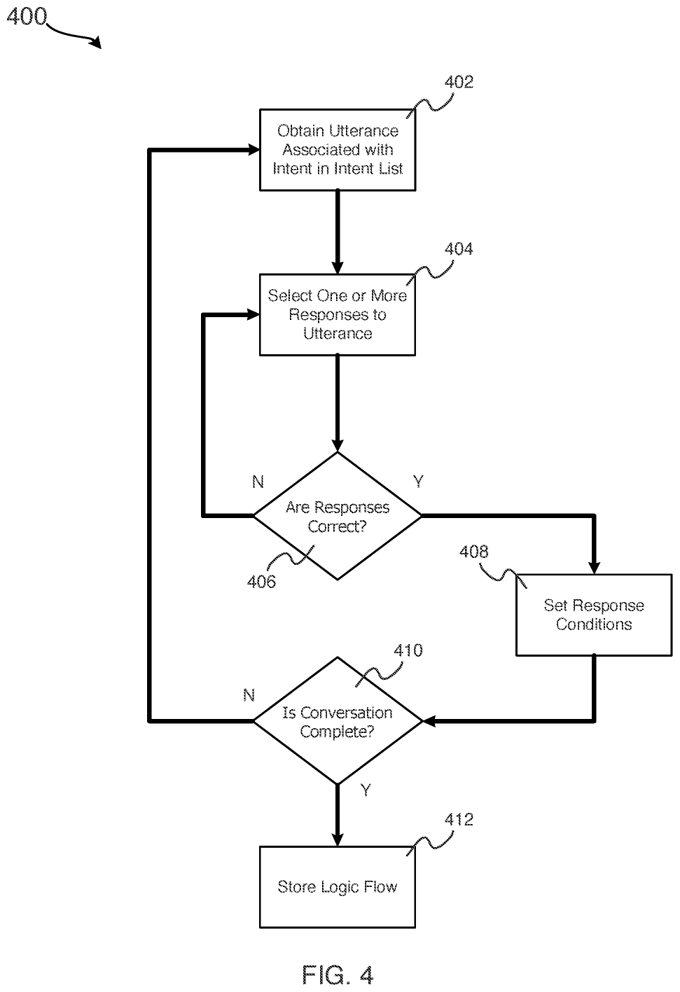

FIG. 4 illustrates a method 400 by which a chatbot-training system can develop logic flows for an intent list (for example, an intent list created from a customized intent hierarchy) while significantly reducing the input necessary for chatbot trainers. Method 400 may develop logic flows by staging and storing training conversations for a set of intents. Method 400 begins at block 402, in which an utterance associated with an intent in an intent list is obtained. The manner by which the utterance is obtained may vary based on the embodiment and use case. In some embodiments, for example, this utterance may be obtained by selecting a random intent in the intent list and selecting a random utterance associated with that intent. In other embodiments, an utterance associated with a greeting intent may be chosen. In other embodiments, the chatbot-training system may prompt a chatbot trainer to select an utterance (for example, a chatbot trainer may select from a set of utterances displayed on a graphic-user interface or may search the intent hierarchy for an intent or utterance).

Once an utterance is obtained, that utterance may be displayed as the chatbot trainer's first utterance in the staged training conversation. At that point, the chatbot-training system may select a response to the obtained utterance in block 404. The chatbot-training system may select this utterance based on, for example, structured historical conversations. The chatbot-training system may also base the selection on input from a chatbot-trainer. In some embodiments, for example, the chatbot trainer may select one or more responses from a list of proposed responses, or may type the response into the conversation.

In some embodiments, more than one response for a single utterance may be selected. As discussed previously, for example, providing a complete response to some chatbot-trainer questions may require the chatbot-training system to first ask the chatbot trainer a series of questions. For example, the chatbot-training system may not be able to answer the question “what is the minimum I could pay for health insurance” without first asking the chatbot trainer where he or she lives, how many people will be covered for the health insurance, and whether he or she has pre-existing health conditions.

After the response or responses are selected, the chatbot-training system may then present the response or responses to a chatbot trainer. The chatbot-training system may then determine, in block 406, whether the responses are correct based on the chatbot-trainer's input. In some embodiments in which the one or more responses are provided by the chatbot trainer, the responses may be automatically assumed to be correct.

If the chatbot-training system determines, in block 406, that the responses are not correct, the chatbot-training system returns to block 404 to select a new response or new responses to the utterance that was obtained in block 402.

If, on the other hand, the chatbot-training system determines that the responses are correct, the chatbot-training system may set any applicable response conditions for the responses in block 408. As discussed previously, response conditions are used to set the conditions under which a response or set of responses to a single end-user utterance are transmitted to the end user. For example, if a single end-user utterance requires two responses to be fully addressed, the responses may be categorized as an initial response and subsequent response. In this example, a response condition may establish the conditions under which the subsequent response is transmitted to the end user. The nature of response conditions can vary based on the embodiment and the purpose of response conditions. For example, a common response condition may wait to send the subsequent response until after the chatbot has confirmed that it has received a satisfactory answer to the first response. A common response condition may be an if-then-else condition, in which a first subsequent response may be sent in if a first condition is met, but a second subsequent response may be sent if a second condition is met. More examples of response conditions and further description may be found following the description of FIG. 1.

In some embodiments, the chatbot-training system may, for example, propose response conditions for the selected response or responses (for example, the response conditions may be based on historical conversation data). In some embodiments, the response conditions may be selected by a chatbot trainer, and set based on that selection.

After the response conditions are set in block 408, the chatbot-training system may determine whether the conversation is complete in block 410. The nature or basis of this decision may vary based on the embodiments and use case. In some embodiments, for example, the chatbot-training system may request that a chatbot trainer select whether the conversation is complete. In some embodiments, the decision may be based at least partly on the amount of time that has elapsed since the chatbot trainer has provided a message. In other embodiments, the decision may be made based on whether the last utterance was associated with a “farewell” intent.

In some embodiments, the determination in block 410 may include a request for a chatbot trainer to review the properties of the staged conversation and approve or deny the conversation. In these embodiments, a chatbot-training system may not determine that the conversation is complete if the chatbot trainer denied the conversation.

If the chatbot-training system determines that the conversation is not complete, the chatbot-training system returns to block 402 to obtain a further utterance to be added to the conversation. If the chatbot-training system determines, however, that the conversation is complete, the chatbot-training system stores the staged training conversation in block 412.

As has been discussed previously, a neural network may process and analyze input data (for example, unstructured historical conversations or utterances submitted to a chatbot) by recognizing patterns in the input data and comparing those patterns to patterns related to historical logic drops on which the neural network has been trained. For example, a neural network may recognize several patterns in the data expressed by an input vector. The neural network may then associate some of those patterns with the patterns associated with historical conversation data (or other historical conversation data) that the neural network has been trained (e.g., by human-supervised training or automatic training) to associate with, for example, the intents a list of intents.

In some embodiments, data input into a neural network may take the form of a vector. A vector may be a one-dimension matrix (e.g., a matrix with one row and many columns) of numbers, each of which expresses data related to, for example, image analysis (for example, for recognizing text in screenshots of historical conversations), audio analysis (for example, for recognizing dialogue in an audio log of a phone call) and natural-language processing. A vector may also be referred to herein as an “input vector,” a “feature vector,” or a “multi-dimension vector.” For example, this vector may include properties of an utterance that is being analyzed.

Such a neural network is illustrated in FIG. 4. In FIG. 4, neural network 400 may be trained to structure unstructured historical conversation data or to determine a confidence value that an utterance should be associated with a particular intent. The inputs of neural network 400 are represented by feature vectors 402-l through 402-k. These feature vectors may contain all information that is available regarding an utterance. In some embodiments, feature vectors 402-l through 402-k may be identical copies of each other. In some embodiments, more of instances of feature vectors 402 may be utilized. The number of feature vectors 402-l through 402-k may correspond to the number of neurons in feature layer 404. In other words, in some embodiments, the number of inputs 402-l through 402-k (i.e., the number represented by m) may equal (and thus be determined by) the number of first-layer neurons in the network. In other embodiments, neural network 400 may incorporate 1 or more bias neurons in the first layer, in which case the number of inputs 402-l through 402-k may equal the number of first-layer neurons in the network minus the number of first-layer bias neurons.

Feature layer 404 contains neurons 401-l through 401-m. Neurons 404-l through 404-m accept as inputs feature vectors 402-l through 402-k and process the information therein. Once vectors 402-l through 402-k are processed, neurons 404-l through 404-m provide the resulting values to the neurons in hidden layer 406. These neurons, 406-l through 406-n, further process the information, and pass the resulting values to the neurons in hidden layer 408. Similarly, neurons 408-l through 408-o further process the information and pass it to neurons 410-l through 410-p. Neurons 410-l thorough 410-p process the data and deliver it to the output layer of the neural network, which, as illustrated, contains neuron 412. Neuron 412 may be trained to calculate two values—value 414 and value 416. Value 414 may represent the likelihood that an utterance is associated with an intent that is associated with neural network 500. Value 416, on the other hand, may represent the likelihood that the utterance is not associated with that intent.

In some embodiments, neural network 400 may have more than 5 layers of neurons (as presented) or fewer than 5 layers. These 5 layers may each comprise the same amount of neurons as any other layer, more neurons than any other layer, fewer neurons than any other layer, or more neurons than some layers and fewer neurons than other layers. Finally, in some embodiments, the output of output layer 412 may be used to determine the intent of an utterance received by a chatbot, which may then be used to determine an appropriate response to the utterance.

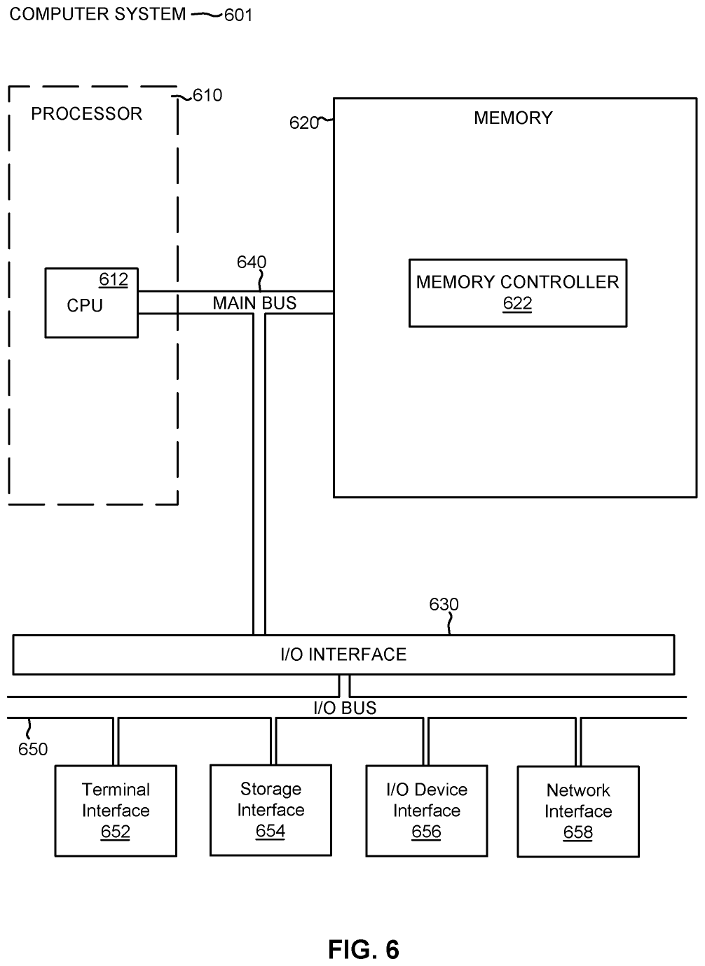

FIG. 6 depicts the representative major components of an example Computer System 601 that may be used in accordance with embodiments of the present disclosure. The particular components depicted are presented for the purpose of example only and are not necessarily the only such variations. The Computer System 601 may include a Processor 610, Memory 620, an Input/Output Interface (also referred to herein as I/O or I/O Interface) 630, and a Main Bus 640. The Main Bus 640 may provide communication pathways for the other components of the Computer System 601. In some embodiments, the Main Bus 640 may connect to other components such as a specialized digital signal processor (not depicted).

The Processor 610 of the Computer System 601 may include one or more CPUs 612. The Processor 610 may additionally include one or more memory buffers or caches (not depicted) that provide temporary storage of instructions and data for the CPU 612. The CPU 612 may perform instructions on input provided from the caches or from the Memory 620 and output the result to caches or the Memory 620. The CPU 612 may include one or more circuits configured to perform one or methods consistent with embodiments of the present disclosure. In some embodiments, the Computer System 601 may contain multiple Processors 610 typical of a relatively large system. In other embodiments, however, the Computer System 601 may be a single processor with a singular CPU 612.

The Memory 620 of the Computer System 601 may include a Memory Controller 622 and one or more memory modules for temporarily or permanently storing data (not depicted). In some embodiments, the Memory 620 may include a random-access semiconductor memory, storage device, or storage medium (either volatile or non-volatile) for storing data and programs. The Memory Controller 622 may communicate with the Processor 610, facilitating storage and retrieval of information in the memory modules. The Memory Controller 622 may communicate with the I/O Interface 630, facilitating storage and retrieval of input or output in the memory modules. In some embodiments, the memory modules may be dual in-line memory modules.

The I/O Interface 630 may include an I/O Bus 650, a Terminal Interface 652, a Storage Interface 654, an I/O Device Interface 656, and a Network Interface 658. The I/O Interface 630 may connect the Main Bus 640 to the I/O Bus 650. The I/O Interface 630 may direct instructions and data from the Processor 610 and Memory 620 to the various interfaces of the I/O Bus 650. The I/O Interface 630 may also direct instructions and data from the various interfaces of the I/O Bus 650 to the Processor 610 and Memory 620. The various interfaces may include the Terminal Interface 652, the Storage Interface 654, the I/O Device Interface 656, and the Network Interface 658. In some embodiments, the various interfaces may include a subset of the aforementioned interfaces (e.g., an embedded computer system in an industrial application may not include the Terminal Interface 652 and the Storage Interface 654).

Logic modules throughout the Computer System 601—including but not limited to the Memory 620, the Processor 610, and the I/O Interface 630—may communicate failures and changes to one or more components to a hypervisor or operating system (not depicted). The hypervisor or the operating system may allocate the various resources available in the Computer System 601 and track the location of data in Memory 620 and of processes assigned to various CPUs 612. In embodiments that combine or rearrange elements, aspects of the logic modules' capabilities may be combined or redistributed. These variations would be apparent to one skilled in the art.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method comprising:
obtaining a set of utterances;
identifying a set of intents associated with utterances within the set of utterances;
organizing intents within the set of intents hierarchically, resulting in an intent hierarchy;
customizing the intent hierarchy to reflect an intended granularity of a chatbot, resulting in a customized intent hierarchy; and
creating a list of intents within the customized intent hierarchy.

2. The method of claim 1, wherein the customizing comprises:
presenting, by a graphical user interface, a first utterance to a chatbot trainer;
obtaining a response to the first utterance;
presenting, by the graphical user interface, a second utterance to the chatbot trainer;
receiving an indication that the response could also address the second utterance;
identifying a first intent that is associated with the first utterance;
identifying a second intent that is associated with the second utterance;
merging, based on the receiving, the first intent and the second intent.

3. The method of claim 1, wherein the intent hierarchy is organized into intent clusters.

4. The method of claim 3, wherein the intent hierarchy comprises an intent cluster associated with common utterances.

5. The method of claim 1, wherein the customizing comprises merging a first intent and a second intent into a single intent.

6. The method of claim 1, wherein the customizing comprises deleting an intent from the intent hierarchy.

7. The method of claim 1, further comprising staging a training conversation for a set of intents within the intent hierarchy.

8. The method of claim 7, further comprising creating a stored logic flow based on the training conversation.

9. The method of claim 8, wherein the training conversation includes a response condition.

10. A system comprising:
a processor; and
a memory in communication with the processor, the memory containing program instructions that, when executed by the processor, are configured to cause the processor to perform a method, the method comprising:
obtaining a set of utterances;
identifying a set of intents associated with utterances within the set of utterances;
organizing intents within the set of intents hierarchically, resulting in an intent hierarchy;
customizing the intent hierarchy to reflect an intended granularity of a chatbot, resulting in a customized intent hierarchy; and
creating a list of intents within the customized intent hierarchy.

11. The system of claim 10, wherein the method performed by the processor further comprises:
presenting, by a graphical user interface, a first utterance to a chatbot trainer;
obtaining a response to the first utterance;
presenting, by the graphical user interface, a second utterance to the chatbot trainer;
receiving an indication that the response could also address the second utterance;
identifying a first intent that is associated with the first utterance;
identifying a second intent that is associated with the second utterance;
merging, based on the receiving, the first intent and the second intent.

12. The system of claim 10, wherein the intent hierarchy is organized into intent clusters.

13. The system of claim 10, wherein the customizing comprises merging a first intent and a second intent into a single intent.

14. The system of claim 10, wherein the method performed by the processor further comprises staging a training conversation for a set of intents within the intent hierarchy.

15. The system of claim 14, wherein the method performed by the processor further comprises creating a stored logic flow based on the training conversation.

16. A computer program product, the computer program product comprising a computer readable storage medium having program instructions embodied therewith, the program instructions executable by a computer to cause the computer to:
obtain a set of utterances;
identify a set of intents associated with utterances within the set of utterances;
organize intents within the set of intents hierarchically, resulting in an intent hierarchy;
customize the intent hierarchy to reflect an intended granularity of a chatbot, resulting in a customized intent hierarchy; and
create a list of intents within the customized intent hierarchy.

17. The computer program product of claim 16, wherein the program instructions further cause the computer to:
present, by a graphical user interface, a first utterance to a chatbot trainer;
obtain a response to the first utterance;
present, by the graphical user interface, a second utterance to the chatbot trainer;
receive an indication that the response could also address the second utterance;
identify a first intent that is associated with the first utterance;
identify a second intent that is associated with the second utterance;
merge, based on the receiving, the first intent and the second intent.

18. The computer program product of claim 16, wherein the customizing comprises merging a first intent and a second intent into a single intent.

19. The computer program product of claim 16, wherein the program instructions further cause the computer to stage a training conversation for a set of intents within the intent hierarchy.

20. The computer program product of claim 19, wherein the program instructions further cause the computer to create a stored logic flow based on the training conversation.
